(19) United States
(12) Patent Application Publication
(10) Pub. No.: US 2023/0382237 A1
(43) Pub. Date: Nov. 30, 2023

(54) RAILWAY-VEHICLE POWER CONVERSION APPARATUS

(71) Applicants: KABUSHIKI KAISHA TOSHIBA, Tokyo (JP); Toshiba Infrastructure Systems & Solutions Corporation, Kawasaki-shi (JP)

(72) Inventors: Masaya MISUMI, Tokyo (JP); Tomoyuki MAKINO, Iruma (JP)

(73) Assignees: KABUSHIKI KAISHA TOSHIBA, Minato-ku, Tokyo (JP); Toshiba Infrastructure Systems & Solutions Corporation, Kawasaki-shi, Kanagawa (JP)

(21) Appl. No.: 18/449,910

(22) Filed: Aug. 15, 2023

Related U.S. Application Data
(63) Continuation of application No. PCT/JP2022/003213, filed on Jan. 28, 2022.

(30) Foreign Application Priority Data
Feb. 16, 2021 (JP) 2021-022364

(51) Int. Cl. B60L 15/00; H02M 1/32; H02M 7/00

(52) U.S. Cl. CPC B60L 15/007; H02M 1/327; H02M 7/003; B60L 2200/26

(57) ABSTRACT

According to an embodiment, a railway-vehicle power conversion apparatus includes a power conversion unit including: a converter unit; an inverter unit; and a cooler, and in the power conversion unit, the converter unit and the inverter unit are disposed at a predetermined interval on the cooler, and an overvoltage suppression unit is disposed on the same cooler on which the converter unit and the inverter unit are disposed.

### CROSS-REFERENCE TO RELATED APPLICATION

This application is a Continuation application of PCT Application No. PCT/JP2022/003213, filed Jan. 28, 2022 and based upon and claiming the benefit of priority from Japanese Patent Application No. 2021-022364, filed Feb. 16, 2021, the entire contents of all of which are incorporated herein by reference.

### FIELD

Embodiments described herein relate generally to a railway-vehicle power conversion apparatus.

### BACKGROUND

A railway-vehicle power conversion apparatus includes a converter unit that converts alternating-current power from an overhead line into direct-current power and an inverter unit that converts the direct-current power from the converter unit into alternating-current power, in which an electric motor is driven by an output from the inverter unit.

An intermediate direct-current unit between the converter unit and the inverter unit is provided with a smoothing capacitor and is further equipped with an overvoltage suppression unit that suppresses overvoltage to the smoothing capacitor.

Jpn. Pat. Appln. KOKAI Publication No. 2013-162695 describes an overvoltage suppression circuit with which an intermediate direct-current unit is provided, in which the overvoltage suppression circuit is located between a converter unit and an inverter unit on a circuit.

However, in a conventional railway-vehicle power conversion apparatus, because a switching element included in a converter unit and a switching element included in an inverter unit are disposed in a limited space, for example, an overvoltage suppression unit requires disposing apart, leading to an increase in the quantity of wiring as a problem.

### BRIEF DESCRIPTION OF THE DRAWING

FIG. 1 illustrates the configuration of a railway-vehicle power conversion apparatus according to a first embodiment.

### DETAILED DESCRIPTION

According to one embodiment, a railway-vehicle power conversion apparatus includes a power conversion unit including: a converter unit; an inverter unit; and a cooler, and in the power conversion unit, the converter unit and the inverter unit are disposed at a predetermined interval on the cooler, and an overvoltage suppression unit is disposed on the same cooler on which the converter unit and the inverter unit are disposed.

Embodiments is to provide a railway-vehicle power conversion apparatus small in size and light in weight with a built-in overvoltage suppression unit as part of a power conversion unit.

Embodiments will be described below with reference to the drawing.

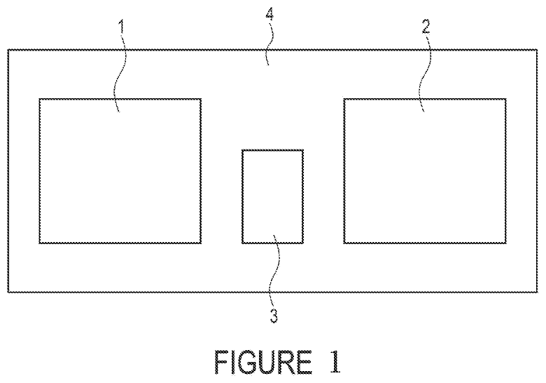

FIG. 1 illustrates the configuration of a railway-vehicle power conversion apparatus according to a first embodiment.

The railway-vehicle power conversion apparatus includes a power conversion unit including a converter unit 1, an inverter unit 2, an overvoltage suppression unit 3, and a cooler 4, in which alternating-current power from an overhead line is subjected to power conversion to supply a drive current to an electric motor such that the electric motor is driven.

The converter unit 1 converts alternating-current power supplied from an overhead line into direct-current power. For example, a switching element used in the converter unit 1 includes a wide-bandgap semiconductor.

The inverter unit 2 converts the direct-current power from the converter unit 1 into alternating-current power. For example, a switching element used in the inverter unit 2 includes a wide-bandgap semiconductor.

The overvoltage suppression unit 3 suppresses overvoltage to a smoothing capacitor provided between the converter unit 1 and the inverter unit 2. For example, the overvoltage suppression unit 3 includes a resistor, a switching element, and a voltage sensor, and controls, in response to detection of overvoltage applied to the smoothing capacitor by the voltage sensor, the switching element on to establish an electric connection between the smoothing capacitor and the resistor, followed by suppression of the overvoltage.

For example, the cooler 4 has an upper face on which the capacitor unit 1, the inverter unit 2, and the overvoltage suppression unit 3 are disposed, and cools each unit.

The converter unit 1 and the inverter unit 2 are disposed on the cooler 4. Referring to FIG. 1, the converter unit 1 and the inverter unit 2 are disposed at a predetermined interval on the cooler 4.

The overvoltage suppression unit 3 is disposed on the cooler 4. Referring to FIG. 1, the overvoltage suppression unit 3 is disposed between the converter unit 1 and the inverter unit 2.

Even regarding an existing railway-vehicle power conversion apparatus, for efficient cooling of a converter unit 1 and an inverter unit 2, the converter unit 1 and the inverter unit 2 are attached to a cooler so as to be cooled.

In this case, the railway-vehicle power conversion apparatus is mounted under the floor of a railway vehicle and thus is limited in terms of outfitting space. Despite such a limited outfitting space, in general, the converter unit 1 and the inverter unit 2 are large in heat generation, and thus the converter unit 1 and the inverter unit 2 each need a cooler. Even in a case where a single cooler cools the converter unit 1 and the inverter unit 2, for efficient use of the cooling performance of the cooler, the converter unit 1 and the inverter unit 2 need disposing without a lack of heat balance.

Thus, an existing railway-vehicle power conversion apparatus has a structure prioritized in the efficiency of cooling, in which a converter unit 1, an inverter unit 2, and a cooler 4 are provided as a power conversion unit. Although an overvoltage suppression unit 3 is present between the converter unit 1 and the inverter unit 2 on an electric circuit, the overvoltage suppression unit 3 is individually attached apart from the converter unit 1 and the inverter unit 2 as the structure of the railway-vehicle power conversion apparatus.

Meanwhile, regarding recent some railway-vehicle power conversion apparatuses, a wide-bandgap semiconductor is adopted for a switching element.

A switching element of a wide-bandgap semiconductor tends to be smaller in switching loss than a switching element of a semiconductor of a conventional material, such as Si, and is capable of operating at high temperature.

Regarding a railway-vehicle power conversion apparatus with such a wide-bandgap semiconductor, even a cooler smaller in size than a conventional cooler can cool the converter unit 1 and the inverter unit 2.

However, as a result of temperature examination of a power conversion unit, a smaller interval between the converter unit 1 and the inverter unit 2 tends to cause a rise in temperature.

That is, the converter unit 1 and the inverter unit 2 are each influenced by heat generated by the other unit, leading to a rise in temperature.

Thus, in the present embodiment, a structure in which the converter unit 1 and the inverter unit 2 are disposed at a predetermined interval on the cooler 4 enables a power conversion unit with no mutual thermal influence.

The converter unit 1 and the inverter unit 2 are spaced apart, causing a space on the cooler 4. Therefore, the overvoltage suppression unit 3 present between the converter unit 1 and the inverter unit 2 on an electric circuit is disposed in the space, resulting in a power conversion unit including the converter unit 1, the inverter unit 2, and the overvoltage suppression unit 3 disposed on the cooler 4, leading to achievement of reductions in size and weight.

Furthermore, since the overvoltage suppression unit 3 includes the resistor that consumes power at the time of discharge, the resistor can be cooled by the cooler 4. Reductions in size and weight can be achieved even with the cooler 4 that cools the overvoltage suppression unit 3. Therefore, in order to prioritize a reduction in inductance (including wiring inductance) between the inverter unit 2 and the converter unit 1, instead of being disposed between the converter unit 1 and the inverter unit 2, the overvoltage suppression unit 3 may be spaced on the cooler 4 apart from the converter unit 1 and the inverter unit 2 disposed at a predetermined interval on the cooler 4.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A railway-vehicle power conversion apparatus comprising a power conversion unit including:
a converter unit;
an inverter unit; and
a cooler, wherein
in the power conversion unit
the converter unit and the inverter unit are disposed at a predetermined interval on the cooler, and
an overvoltage suppression unit is disposed on the same cooler on which the converter unit and the inverter unit are disposed.

2. The railway-vehicle power conversion apparatus according to claim 1, wherein the overvoltage suppression unit is disposed between the converter unit and the inverter unit in the power conversion unit.
